(19) United States
(12) Patent Application Publication
(10) Pub. No.: US 2026/0343289 A1
(43) Pub. Date: Oct. 29, 2026

(54) Reduced User Equipment Uplink Reporting Overhead

(71) Applicant: Telefonaktiebolaget LM Ericsson (publ), Stockholm (SE)

(72) Inventors: Henrik RYDÉN, Stockholm (SE); Johan AXNÄS, Stockholm (SE); Jingya LI, Göteborg (SE); Andreas NILSSON, Göteborg (SE)

(21) Appl. No.: 19/115,320

(22) PCT Filed: Sep. 28, 2023
(86) PCT No.: PCT/EP2023/076988

§ 371 Date: Mar. 26, 2025

Related U.S. Application Data
(60) Provisional application No. 63/377,546, filed on Sep. 29, 2022.

(51) Int. Cl. H04W 24/10; H04B 7/06

(52) U.S. Cl. CPC H04W 24/10; H04B 7/06952

(57) ABSTRACT

A method in a User Equipment, UE, comprises receiving from a network node an indication of a preferred preprocessing method. The method further comprises performing measurements on a first set of beams and preprocessing the measurements to derive a second set of beams according to the preferred preprocessing method. The method further comprises transmitting a measurement report to the network node, wherein the measurement report comprises measurements for the second set of beams. A method in a network node, comprises transmitting to a User Equipment, UE, an indication of a preferred preprocessing method. The method further comprises receiving a measurement report from the UE, wherein the measurement report comprises measurements for a subset of beams supported by the UE; wherein the subset of beams is a second set of beams derived by the UE from measurements on a first set of beams according to the preferred preprocessing method. The method may further comprise, based on the measurement report and a machine learning model, determining a preferred beam of all beams supported by the UE and communicating with the UE using the preferred beam.

### TECHNICAL FIELD

The present invention relates to a method performed by a wireless device, a method performed by a network node, a network node and a wireless network node.

### BACKGROUND

One key feature of fifth generation (5G) New Radio (NR) wireless networks, compared to previous generation of wireless networks, is the ability to operate in higher frequencies (e.g., above 10 GHz). The available large transmission bandwidths in these frequency ranges potentially provide large data rates. However, as carrier frequency increases, both pathloss and penetration loss increase. To maintain the coverage at the same level, highly directional beams are required to focus the radio transmitter energy in a particular direction on the receiver. However, large radio antenna arrays—at both receiver and transmitter sides—are needed to create such highly directional beams.

To reduce hardware costs, large antenna arrays for high frequencies use time-domain analog beamforming. The core idea of analog beamforming is to share a single radio frequency chain between many (or, potentially, all) of the antenna elements. A limitation of analog beamforming is that it is only possible to transmit radio energy using one beam (in one direction) at a given time.

The above limitation requires the network (NW) and user equipment (UE) to perform beam management procedures to establish and maintain suitable transmitter (Tx)/receiver (Rx) beam-pairs. For example, a transmitter may use beam management procedures to sweep a geographic area by transmitting reference signals on different candidate beams, during non-overlapping time intervals, using a predetermined pattern. By measuring the quality of the reference signals at the receiver side, the best transmit and receive beams can be identified.

### NR Beam Management Procedures

Beam management procedures in NR are defined by a set of L1/L2 procedures that establish and maintain a suitable beam pairs for both transmitting and receiving data. A beam management procedure can include the following sub procedures: beam determination, beam measurements, beam reporting, and beam sweeping.

In case of downlink transmission from the network to the UE, P1/P2/P3 beam management procedures can be performed according to the NR SI technical report to overcome the challenges of establishing and maintaining the beam pairs when, for example, a UE moves or a blockage in the environment requires changing the beams. Although these scenarios are not directly mentioned in specifications, there are relevant procedures defined that enable the realization of these scenarios, examples of such realization are depicted in the corresponding figure for each scenario:
P1: The P1 procedure is used to enable UE measurement on different transmission/reception point (TRP) Tx beams to support selection of TRP Tx beams/UE Rx beam(s). During initial access, for example, the gNB transmits synchronization signal (SS)/physical broadcast channel (PBCH) block (SSB) beams in different directions to cover the whole cell. The UE measures signal quality on corresponding SSB signals to detect and select an appropriate SSB beam. An example is illustrated in FIG. 1.

Random access is then transmitted on the random access channel (RACH) resources indicated by the selected SSB. The corresponding beam is then used by both the UE and the network to communicate until connected mode beam management is active. The network infers which SSB beam was chosen by the UE without explicit signaling.

For beamforming at TRP, it typically includes an intra/inter-TRP Tx beam sweep from a set of different beams. For beamforming at UE, it typically includes a UE Rx beam sweep from a set of different beams.
P2: The P2 procedure is used to enable UE measurement on different TRP Tx beams to possibly change inter/intra-TRP Tx beam(s). The network can use the SSB beam as an indication of which (narrow) channel state information reference signal (CSI-RS) beams to try; that is, the selected SSB beam can be used to define a candidate set of narrow CSI-RS beams for beam management. Once CSI-RS is transmitted, the UE measures the reference signal receive power (RSRP), and reports the result to the network.

If the network receives a CSI-RSRP report from the UE where a new CSI-RS beam is better than the old used to transmit physical downlink control channel (PDCCH)/physical downlink shared channel (PDSCH), the network updates the serving beam for the UE accordingly, and possibly also modifies the candidate set of CSI-RS beams. The network can also instruct the UE to perform measurements on SSBs. If the network receives a report from the UE where a new SSB beam is better than the previous best SSB beam, a corresponding update of the candidate set of CSI-RS beams for the UE may be motivated.

P2 procedure is performed on a possibly smaller set of beams for beam refinement than in P1. Note that P2 can be a special case of P1. For example, in connected mode gNB configures the UE with different CSI-RSs and transmits each CSI-RS on corresponding beam. UE then measures the quality of each CSI-RS beam on its current RX beam and send feedback about the quality of the measured beams. Thereafter, based on this feedback, gNB will decide and possibly indicate to the UE which beam will be used in future transmissions. An example is illustrated in FIG. 2.
P3: Enables UE measurement on the same TRP Tx beam to change UE Rx beam when the UE uses beamforming. Once in connected mode, the UE is configured with a set of reference signals. Based on measurements, the UE determines which Rx beam is suitable to receive each reference signal in the set. The network then indicates which reference signals are associated with the beam that will be used to transmit PDCCH/PDSCH, and the UE uses this information to adjust its Rx beam when receiving PDCCH/PDSCH.

In connected mode, P3 can be used by the UE to find the best Rx beam for corresponding Tx beam. In this case gNB keeps one CSI-RS Tx beam at a time, and UE performs the sweeping and measurements on its own Rx beams for that specific Tx beam. UE then finds the best corresponding Rx beam based on the measurements and will use it in future for reception when gNB indicates the use of that Tx beam.

### Beam Measurement and Reporting in NR

For beam management, a UE can be configured to report RSRP or/and signal to interference and noise ratio (SINR) for each one of up to four beams, either on CSI-RS or SSB. UE measurement reports can be sent either over physical uplink control channel (PUCCH) or physical uplink shard channel (PUSCH) to the network node, e.g., gNB.

### Reference Signal Configurations in NR

### CSI-RS:

A CSI-RS is transmitted over each transmit (Tx) antenna port at the network node and for different antenna ports. The CSI-RS are multiplexed in time, frequency, and code domain such that the channel between each Tx antenna port at the network node and each receive antenna port at a UE can be measured by the UE. The time-frequency resource used for transmitting CSI-RS is referred to as a CSI-RS resource.

In NR, the CSI-RS for beam management is defined as a 1- or 2-port CSI-RS resource in a CSI-RS resource set where the filed repetition is present. The following three types of CSI-RS transmissions are supported:

Periodic CSI-RS: CSI-RS is transmitted periodically in certain slots. This CSI-RS transmission is semi-statically configured using RRC signaling with parameters such as CSI-RS resource, periodicity, and slot offset.

Semi-Persistent CSI-RS: Similar to periodic CSI-RS, resources for semi-persistent CSI-RS transmissions are semi-statically configured using RRC signaling with parameters such as periodicity and slot offset. However, unlike periodic CSI-RS, dynamic signaling is needed to activate and deactivate the CSI-RS transmission.

Aperiodic CSI-RS: This is a one-shot CSI-RS transmission that can happen in any slot. Here, one-shot means that CSI-RS transmission only happens once per trigger. The CSI-RS resources (i.e., the resource element (RE) locations that consist of subcarrier locations and orthogonal frequency division multiplexing (OFDM) symbol locations) for aperiodic CSI-RS are semi-statically configured. The transmission of aperiodic CSI-RS is triggered by dynamic signaling through PDCCH using the CSI request field in uplink (UL) downlink control information (DCI), in the same DCI where the UL resources for the measurement report are scheduled.

Multiple aperiodic CSI-RS resources can be included in a CSI-RS resource set and the triggering of aperiodic CSI-RS is on a resource set basis.

### SSB:

In NR, an SSB consists of a pair of synchronization signals (SSs), physical broadcast channel (PBCH), and demodulation reference signal (DMRS) for PBCH. An SSB is mapped to 4 consecutive OFDM symbols in the time domain and 240 contiguous subcarriers (20 RBs) in the frequency domain.

NR supports beamforming and beam-sweeping for SSB transmission, by enabling a cell to transmit multiple SSBs in different narrow-beams multiplexed in time. The transmission of these SSBs is confined to a half frame time interval (5 ms). It is also possible to configure a cell to transmit multiple SSBs in a single wide-beam with multiple repetitions. The design of beamforming parameters for each of the SSBs within a half frame is up to network implementation. The SSBs within a half frame are broadcasted periodically from each cell. The periodicity of the half frames with SS/PBCH blocks is referred to as SSB periodicity, which is indicated by SIB1. The maximum number of SSBs within a half frame, denoted by L, depends on the frequency band, and the time locations for these L candidate SSBs within a half frame depends on the subcarrier spacing (SCS) of the SSBs. The L candidate SSBs within a half frame are indexed in an ascending order in time from 0 to L−1. By successfully detecting PBCH and its associated DMRS, a UE knows the SSB index. A cell does not necessarily transmit SS/PBCH blocks in all L candidate locations in a half frame, and the resource of the un-used candidate positions can be used for the transmission of data or control signaling instead. It is up to network implementation to decide which candidate time locations to select for SSB transmission within a half frame, and which beam to use for each SSB transmission.

### Measurement Resource Configurations in NR

A UE can be configured with the following: N≥1 CSI reporting settings (CSI-ReportConfig) and M≥1 resource settings (CSI-ResourceConfig).

Each CSI reporting setting is linked to one or more resource setting for channel and/or interference measurement. The CSI framework is modular in the sense that several CSI reporting settings may be associated with the same Resource Setting.

The measurement resource configurations for beam management are provided to the UE by RRC information element (IE) (CSI-ResourceConfigs). One CSI-ResourceConfig contains several NZP-CSI-RS-ResourceSets and/or CSI-SSB-ResourceSets.

A UE can be configured to measure CSI-RSs using the radio resource control (RRC) IE NZP-CSI-RS-ResourceSet. A NZP CSI-RS resource set contains the configurations of Ks≥1 CSI-RS resources. Each CSI-RS resource configuration resource includes at least the following: mapping to REs, the number of antenna ports, and time-domain behavior.

Up to 64 CSI-RS resources can be grouped together in a NZP-CSI-RS-ResourceSet.

A UE can be configured to measure SSBs using the RRC IE CSI-SSB-ResourceSet. Resource sets comprising SSB resources are defined in a similar manner to the CSI-RS resources defined above.

For aperiodic CSI-RS and/or aperiodic CSI reporting, the network node configures the UE with S_{c} CSI triggering states. Each triggering state contains the aperiodic CSI report setting to be triggered along with the associated aperiodic CSI-RS resource sets.

Periodic and semi-persistent resource settings can only comprise a single resource set (i.e., S=1). Aperiodic resource settings can have many resources sets (S>=1), because one out of the S resource sets defined in the resource setting is indicated by the aperiodic triggering state that triggers a CSI report.

### Measurement Reporting

Three types of CSI reporting are supported in NR as follows:

Periodic CSI Reporting on PUCCH: CSI is reported periodically by a UE. Parameters such as periodicity and slot offset are configured semi-statically by higher layer RRC signaling from the network node to the UE

Semi-Persistent CSI Reporting on PUSCH or PUCCH: similar to periodic CSI reporting, semi-persistent CSI reporting has a periodicity and slot offset which may be semi-statically configured. However, a dynamic trigger from network node to UE may be needed to allow the UE to begin semi-persistent CSI reporting. A dynamic trigger from network node to UE is needed to request the UE to stop the semi-persistent CSI reporting.

Aperiodic CSI Reporting on PUSCH: This type of CSI reporting involves a single-shot (i.e., one time) CSI report by a UE which is dynamically triggered by the network node using DCI. Some of the parameters related to the configuration of the aperiodic CSI report is semi-statically configured by RRC but the triggering is dynamic

In each CSI reporting setting, the content and time-domain behavior of the report is defined, along with the linkage to the associated Resource Settings.

The CSI-ReportConfig 1E comprise the following configurations:

reportConfigType

Defines the time-domain behavior (periodic CSI reporting, semi-persistent CSI reporting, or aperiodic CSI reporting) along with the periodicity and slot offset of the report for periodic CSI reporting.

reportQuantity

Defines the reported CSI parameters—the CSI content; for example, the precoding matrix indicator (PMI), channel quality indicator (CQI), rank indicator (RI), LI (layer indicator), CRI (CSI-RS resource index) and LI-RSRP. Only certain combinations are possible; for example, ‘cri-RI-PMI-CQI’ is one possible value and ‘cri-RSRP’ is another) and each value of reportQuantity could be said to correspond to a certain CSI mode.

codebookConfig

Defines the codebook used for PMI reporting, along with possible codebook subset restriction (CBSR). NR supported the following two types of PMI codebooks: Type I CSI and Type II CSI. Additionally, the Type I and Type II codebooks each have two different variants: regular and port selection.

reportFrequencyConfiguration

Define the frequency granularity of PMI and CQI (wideband or subband), if reported, along with the CSI reporting band, which is a subset of subbands of the bandwidth part (BWP) which the CSI corresponds to

### Measurement Restriction in Time Domain (ON/OFF) for Channel and Interference Respectively

For beam management, a UE can be configured to report LI-RSRP for up to four different CSI-RS/SSB resource indicators. The reported RSRP value corresponding to the first (best) CRI/SSBRI requires 7 bits, using absolute values, while the others require 4 bits using encoding relative to the first. In NR release 16, the report of LI-SINR for beam management has already been supported.

During the 3GPP meeting RANI #109-e it was agreed to study AI/ML based spatial beam prediction, the core idea of which is as follows: Predict the “best” beam (or beams) from a Set A of beams using measurement results from another Set B of beams.

Set A and Set B of beams have not been defined, however, the following two examples illustrate some scenarios that will likely be studied in Release 18:

Set B is a subset of a Set A. For example, Set A is a set of 8 SSB/CSI-RS beams shown in FIG. 4 (both light and dark circles). The UE measures Set B (the 4 beams indicated by dark circles). The AI/ML model should predict the best beam (or beams) in Set A using only measurements from Set B. FIG. 4 illustrates a grid-of-beam type radiation pattern: Each row (resp. column) depicts a certain zenith (resp. azimuth) angle from the antenna array. Set A has 8 beams and Set B has 4 beams (indicated by dark circles).

Set A and Set B correspond to two different sets of beams. For example, as shown in FIG. 5, Set A could be a set of 30 narrow CSI-RS beams, and Set B could be a set of 8 wide SSB beams. The UE measures beams in Set B and the AI/ML model should predict the best beam(s) from Set A.

The spatial beam prediction can be performed in the gNB or the UE—the study item will cover both scenarios.

During the 3GPP meeting RANI #110, it was agreed to study artificial intelligence (AI)/machine learning (ML) model training both at the network, NW, and user equipment, UE, side. Which side that performs the training is expected to impact how data collection is performed, where another agreement is to study the aspect of data collection for beam management. Moreover, it was agreed to study the aspect of model monitoring and the standard impact on AI/ML model inference (e.g. reporting of predicted values). A new key performance indicator (KPI) on uplink control information report overhead was agreed to be further studied as one of the KPI options. It was also agreed to study an option, where Set B is variable, e.g., different beams (pairs) patterns in each report/measurement during training and/or inference.

### ML Model

An ML-model usually represents a functional mapping f between a set of features x, which provide the input argument to the function represented by the model, and an output y representing the transformation of the input feature. Both the input feature x and the output y may be multidimensional tensors.

Training to obtain the model comprises finding the optimal mapping of x to y. Where optimal is defined according to a certain loss function, for example in linear regression problem, a typical loss function minimizes the mean squared error of the model output and the true value. Moreover, it is possible to include the importance of a certain sample in the loss function by including a sample weight term wₛ. Accordingly, an example of a loss function can be defined as minimizing the weighted mean squared error (MSE):

$$\frac{1}{N} {\sum }_{s} {{w}_{s} ( f ( {x}_{s} ) - {y}_{true \_ s} )}^{2} \qquad ( 1 )$$

Finding an appropriate model f depends on several factors such as amount of available data, computational power, and performance requirements associated to the model. There is a vast number of algorithms available, and the exact algorithm should be selected on a use case basis.

### SUMMARY

There currently exist certain challenges. For example, as indicated by the agreed KPI in evaluating the overhead in beam reporting in 3GPP Rel-18 study item, the UE uplink overhead in beam reporting might be large and can limit the gains for NW sided beam prediction. For example, in NW-sided beam prediction, the UE needs to report all beams in set B. Typical values evaluated in the 3GPP study item are more than 8 beams in set B. Large overhead in UE beam reporting does not only lead to decreased UE energy efficiency, but it can also lead to a lack of uplink resources at high NW load/traffic situation which implies an overall system performance degradation.

Furthermore, the Applicant has appreciated that some UEs might not require always being served by the strongest beam and can benefit from some relaxed requirement in using the strongest beam for the sake of reducing its beam reporting overhead. However, there is no such possibility in the standard for UEs to provide its preferred trade-off, nor are there any models able to cope with limited reporting in existing prior art.

The present invention is defined in the claims, to which reference is now directed.

According to an aspect, a method performed by a User Equipment, UE, is provided. The method comprises receiving from a network node an indication of a preferred preprocessing method. The method further comprises performing measurements on a first set of beams and preprocessing the measurements to derive a second set of beams according to the preferred preprocessing method. The method further comprises transmitting a measurement report to the network node, wherein the measurement report comprises measurements for the second set of beams.

The method may further comprise transmitting to a network node an indication of a capability of the UE for preprocessing beam measurements.

The method may further comprise transmitting to a network node an indication of a capability of the UE for reporting beam measurements that have been preprocessed using the preferred preprocessing method.

The method may further comprise transmitting to a network node an indication of a preferred ratio of beam prediction accuracy and reporting overhead.

According to embodiments, the preprocessing may comprise selecting a subset of the first set of beams; wherein the second set of beams is the subset of the first set of beams.

For example, the preprocessing may comprise selecting a subset of the first set of beams based on whether a signal quality measurement value for a beam is within a threshold range, X, of a highest signal quality measurement value for a beam in the first set of beams.

In another example, the preprocessing may comprise selecting a subset of the first set of beams based on whether a signal quality measurement value for a beam is within the highest K measurement signal quality values for the first set of beams.

In another example, the preprocessing may comprise selecting a subset of the first set of beams based on whether a signal quality measurement value for a beam is below a signal quality measurement threshold, x.

According to embodiments, the first set of beams may be a subset of all beams supported by the wireless device, for example Set B beams as described above.

Further, according to an embodiment, receiving, from the network node, the indication of the preferred preprocessing method may comprise receiving a message from the network node comprising a parameter.

The parameter may be for use as a criterion for whether to select a beam from the first set of beams for inclusion in the second set of beams.

For example, the parameter may comprise a value for a signal quality measurement threshold range, X; a value for a number, K, of highest signal quality measurements; or a value for a signal quality measurement threshold, x.

In embodiments, the message may be a Radio Resource Control, RRC, message, a system information message or a Downlink Control Information, DCI.

In an example, receiving, from the network node, the indication of the preferred preprocessing method comprises receiving a RRC message comprising a set of values for the parameter and receiving a DCI indicating a selected value from the set of values.

According to an embodiment, the measurement report may comprise a first part and a second part, wherein the first part comprises an indication of a number of beams for which measurements are included in the second part.

In a preferred embodiment, a number of bits used to report a measurement for at least one of the second set of beams depends on the preferred preprocessing method.

In another preferred embodiment, a granularity of a measurement reported for at least one of the second set of beams depends on the preferred preprocessing method.

According to a further aspect, a method performed by a network node is provided. The method comprises transmitting to a User Equipment, UE, an indication of a preferred preprocessing method. The method further comprises receiving a measurement report from the UE, wherein the measurement report comprises measurements for a subset of beams supported by the UE; wherein the subset of beams is a second set of beams derived by the UE from measurements on a first set of beams according to the preferred preprocessing method.

The method may further comprise, based on the measurement report and a machine learning model, determining a preferred beam of all beams supported by the UE; and communicating with the UE using the preferred beam.

The method may further comprise receiving from a UE an indication of a capability of the wireless device for preprocessing beam measurements.

The method may further comprise receiving from a UE an indication of a preferred ratio of beam prediction accuracy and reporting overhead.

According to a further aspect, a further method performed by a User Equipment, UE, is provided. The method comprises receiving, from a network node, an indication of a pre-processing method. The method further comprises receiving, from the network node, a measurement report comprising measurements for a subset of beams supported by the network node. The method further comprises pre-processing the measurement report according to the indicated preprocessing method and, based on the pre-processed measurement report and a machine learning model, determining a preferred beam of all beams supported by the network node.

According to an embodiment, the pre-processing may comprise assigning one or more non-reported beams a fixed value.

The indication of the pre-processing method may comprise the fixed value.

According to this aspect, there is further provided a method performed by a network node. The method comprises transmitting, to the UE, an indication of a pre-processing method. The pre-processing method is for the wireless device to use to pre-process a measurement report from the network node, the measurement report comprising measurements for a subset of beams supported by the network node, prior to the UE determining, based on the pre-processed measurement report and a machine learning model, a preferred beam of all beams supported by the network node. The method further comprises transmitting, to the User Equipment, a measurement report comprising measurements for a subset of beams supported by the network node.

The method may further comprise performing measurements on a first set of beams.

There is further provided a User Equipment, UE, comprising processing circuitry configured to perform any of the above methods described as performed by a UE. The UE may further comprise power supply circuitry configured to supply power to the UE.

There is further provided a network node comprising processing circuitry configured to perform any of the above methods described as performed by network node. The UE may further comprise power supply circuitry configured to supply power to the network node.

Certain embodiments may provide one or more of the following technical advantages.

For example, particular embodiments reduce beam management reporting overhead without substantially reducing beam prediction accuracy. The reduced amount of UE reporting implies less signaling overhead for the UE and thus provides more energy efficient operations.

The network can at high traffic load situation activate the use of more efficient UE reporting while not substantially reducing the beam prediction accuracy. The uplink resources are typically a major bottleneck at high load. Particular embodiments reduce such issue via reducing the beam management reporting overhead.

In particular embodiments, a UE indicates CSI measurement pre-processing capability, CSI report capability, and/or its preferred trade-off between accuracy and reporting overhead. This enables, for example, battery constrained devices to limit reporting overhead with only a slightly degraded beam selection accuracy.

### BRIEF DESCRIPTION OF THE FIGURES

Some of the embodiments contemplated herein will now be described more fully with reference to the accompanying drawings. Embodiments are provided by way of example to convey the scope of the subject matter to those skilled in the art.

FIG. 1 shows SSB beam selection as part of Initial access procedure according to P1 scenario;

FIG. 2 shows CSI-RS Tx beam selection in Downlink according to P2 scenario;

FIG. 3 shows UE Rx beam selection for corresponding CSI-RS Tx beam in DL according to P3 scenario;

FIG. 4 illustrates an example grid-of-beam type radiation pattern, where Set B is a subset of Set A;

FIG. 5 illustrates an example where Set A is a set of narrow beams and Set B is a set of wide beams;

FIG. 6 is a flow chart for model training according to particular embodiments;

FIG. 7 is a flow chat for model inference according to particular embodiments;

FIG. 8 is an overview of example AI/ML model inference stages for NW-sided beam prediction;

FIG. 9 is a graph showing example performance for reduced reporting, CDF (over all samples/UEs) of RSRP difference between best beam and selected beam;

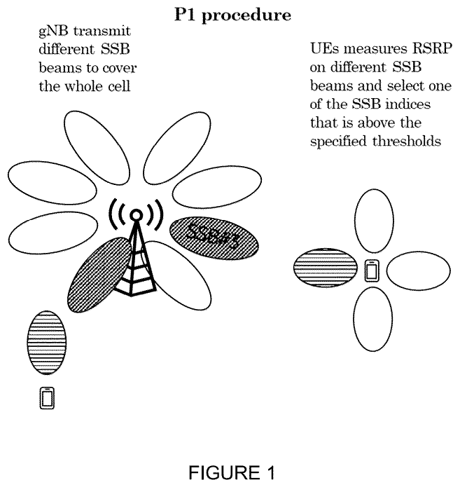

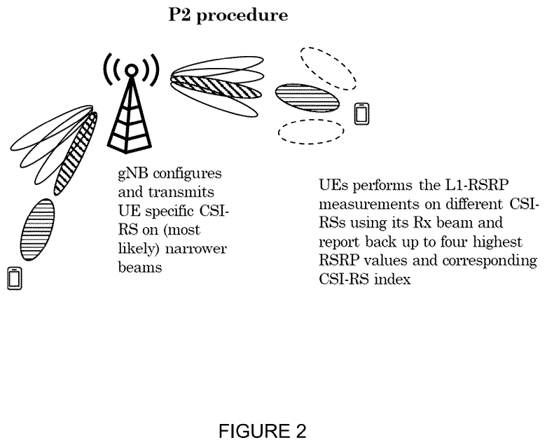

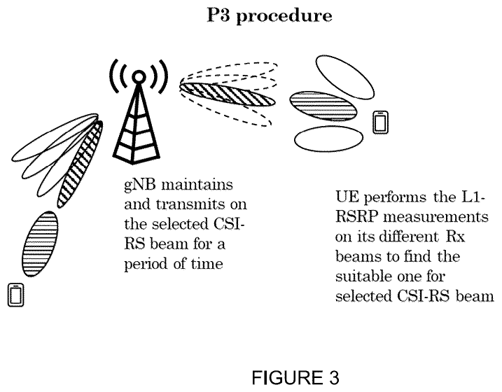

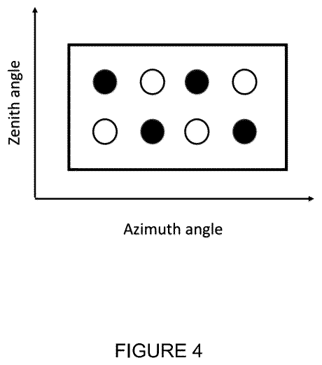

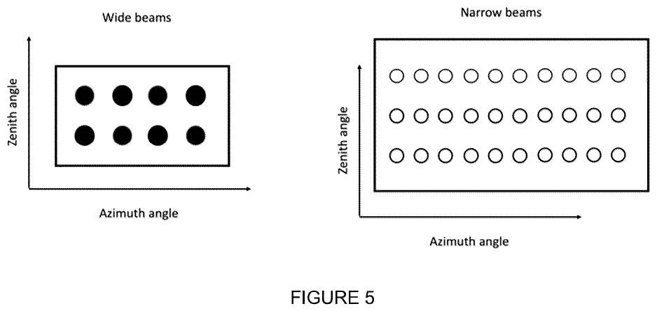

### <Description of New Flow Charts>

FIG. 14 shows an example of a communication system in accordance with some embodiments;

FIG. 15 shows a UE in accordance with some embodiments;

FIG. 16 shows a network node in accordance with some embodiments;

FIG. 17 is a block diagram of a host, which may be an embodiment of the host of FIG. 14, in accordance with various aspects described herein;

FIG. 18 is a block diagram illustrating a virtualization environment in which functions implemented by some embodiments may be virtualized;

FIG. 19 shows a communication diagram of a host communicating via a network node with a UE over a partially wireless connection in accordance with some embodiments.

### DETAILED DESCRIPTION

Certain aspects of the disclosure and their embodiments may provide solutions to the above or other challenges. For example, particular embodiments reduce the beam management (BM) related CSI reporting overhead by performing pre-processing of the CSI measurements at the UE prior to performing CSI reporting and subsequent NW-sided model inference (beam prediction). Particular embodiments includes methods for a NW to train a model with pre-processing, indicating to the UE the selected pre-processing method to use for its CSI reporting, and also methods for the UE to indicate its beam/CSI measurement pre-processing capability, beam prediction related CSI reporting capability, and/or a preferred trade-off the beam prediction accuracy and the reporting overhead. In addition, new beam reporting structures are disclosed that could be used to adapt the beam reporting overhead and/or beam reporting accuracy according to the proposed methods.

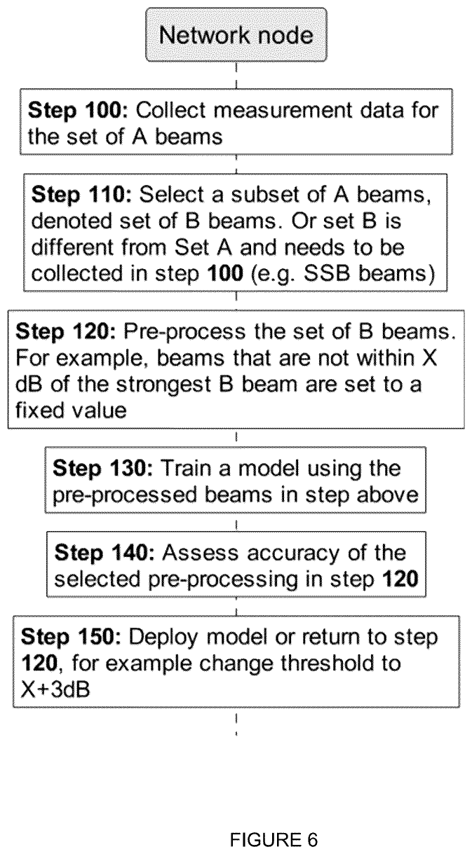

The steps of particular embodiments for training the AI/ML model are illustrated in FIG. 6.

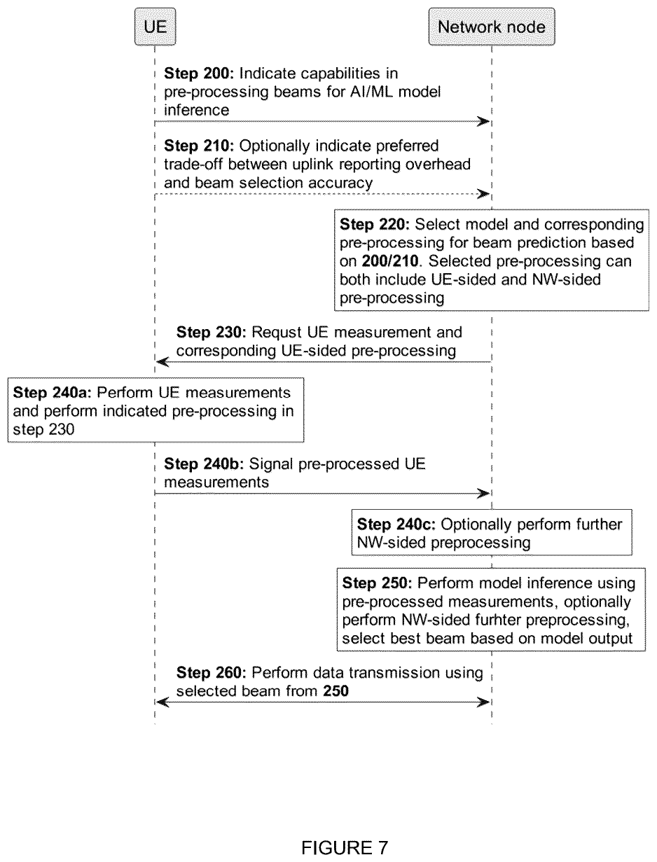

The steps of particular embodiments for AI/ML model inference are illustrated in FIG. 7.

Particular embodiments may be summarized according to the following outline.

### Training:

1. [core]
   a. Pre-process RSRP measurements
   b. Train an ML model with the pre-processed RSRP values as input
2. [pre-processing methods]
   a. Bullet 1, with the pre-processing involving setting some beam RSRP values to a fixed value or a set of fixed values
   b. Bullet 1a with the setting of a fixed value for a beam RSRP value is based on the RSRP value is below some threshold X and/or not among the K largest RSRP value
      Inference (if AI/ML in gNB):
1. [core]
   a. UE receiving instructions on how to pre-process beam RSRP measurements before reporting,
   b. The UE performing pre-processing according to such instructions
   c. The UE reporting pre-processed beams
2. [pre-processing methods]
   a. Bullet 1, with the pre-processing involving selecting only a subset of beam RSRP values for reporting
   b. Bullet 2a with the selection being based on whether the RSRP for a beam is below a RSRP X and/or not among the K largest RSRP values
3. [UE capability indication]
   a. Bullet 1. preceded by UE reporting its capability for pre-processing

### Inference (if AI/ML in UE):

1. [core]
   a. UE receiving RSRP reports from gNB, based on gNB beam measurements
   b. UE pre-processing the RSRP reports,
   c. UE performing ML inference using an ML model
2. [pre-processing methods]
   a. Bullet 1 with the pre-processing involving substituting non-reported beams with a fixed value
3. [UE configuration by gNB]
   a. Bullet 1 with gNB configuring UE with (need to be performed prior to bullet 1)
      i. a pre-processing method (e.g. including the fixed value) and/or
      ii. an ML model to be used in bullet 1c

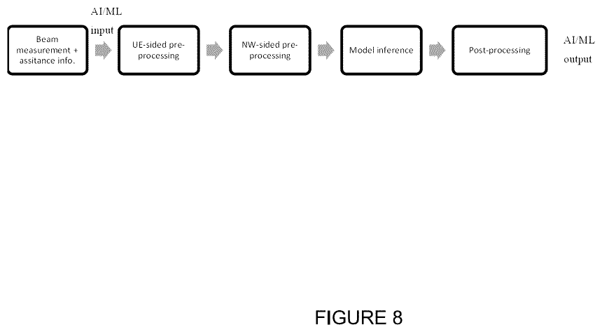

The general stages of network-side beam prediction are highlighted in the flowchart of FIG. 8.

A beam can be associated with a DL-RS resource (e.g., CSI-RS resource, SSB resource), which is transmitted in a spatial direction (e.g., using a spatial domain filter). Thus, different DL-RS resources may correspond to different DL TX beams from the network node. Beam measurements refer to channel measurements performed on the DL-RS resources that the beams are associated with. Beam reports refer to the CSI report generated based on the channel measurements performed on the associated DL-RS resources. As used herein, the terms “beam measurement” and “CSI measurement”, “beam report” and “CSI report” are interchangeable.

The following are particular examples of the elements illustrated in FIG. 8.

AI/ML input: AI/ML input to the pre-processing stage, e.g. beam RSRP measurements, channel impulse response, UE location, UE speed, etc.

UE pre-processing: For example, UE filtering to select K strongest beams to be reported

NW-pre-processing: Pre-processing can, for example, set non-UE reported beam measurements to a fixed value. Also, normalization of all features to be used as input to the model.

Model-inference: For example, in case of training a model to minimize the binary cross-entropy, the output is a value representing the likeliness that each beam is the strongest.

Post-processing/AI/ML output: For example, selecting the top-N beam with highest likeliness of being strongest

### Example Evaluations Using Pre-Processing of Beam Measurements

Particular embodiments are first exemplified by evaluating performance with various degrees of reduced reporting according to some embodiments and comparing it with performance with full reporting. The following cases were considered: (1) No pre-processing: A reference case where RSRP was reported for all measured beams; and (2) UE pre-processing: A reduced-reporting case where measurements were subject to pre-processing, and therefore only a subset of the measured beams were reported (to reduce reporting overhead when ML is performed in gNB). More specifically, the UE pre-processing comprised of beams with RSRP within X dB of the beam with highest RSRP are reported (including information about which beams are reported). Depending on scenario, this may lead to different degrees of reporting overhead reduction. NW pre-processing comprised of setting beams not reported by the UE to a fixed value, and also normalize all input features.

Evaluations of the reporting methods were performed for a scenario with gNBs with 4×8 arrays of cross-polarized antenna elements and UEs having two antenna panels, each consisting of two cross-polarized elements. The UEs were dropped randomly in a macro network with hexagonal structure and inter-site distance 200 m. The channel model is UMa, carrier frequency is 30 MHz and the system bandwidth is 80 MHz. Only outdoor UEs were considered.

The prediction set (Set A) consisted of 30 gNB CSI-RS beams. Two different measurement sets (Set B) were evaluated: (i) 8 half-wide gNB SSB beams; or (ii) 15 gNB CSI-RS beams (i.e., half of the CSI-RS beams).

In both cases it was assumed that each UE for each gNB Tx beam swept all its Rx beams and only reported data for its best Rx beam for each respective gNB Tx beam.

In case (i), pre-processing with X=10 dB resulted in only 45% of the measured beams being reported on average, while in case (ii) X=15 dB resulted in 36% of the measured beams being reported, and X=10 dB resulted in 21% of the measured beams being reported on average.

A neural network (NN) was trained to predict the best CSI-RS beam out of the 30 Set A CSI-RS beams, based on NN input consisting of the RSRP measurements pre-processed as described above to reduce reporting. The NN was trained on many UEs in a single cell and evaluated on the same cell (but with different UE distributions).

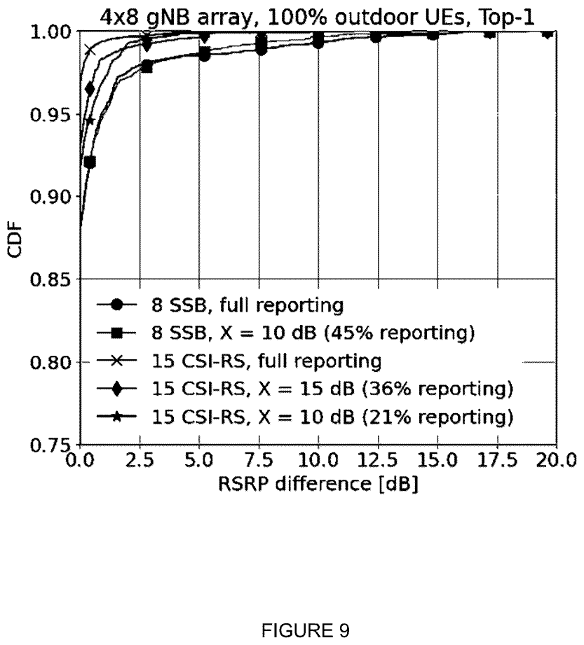

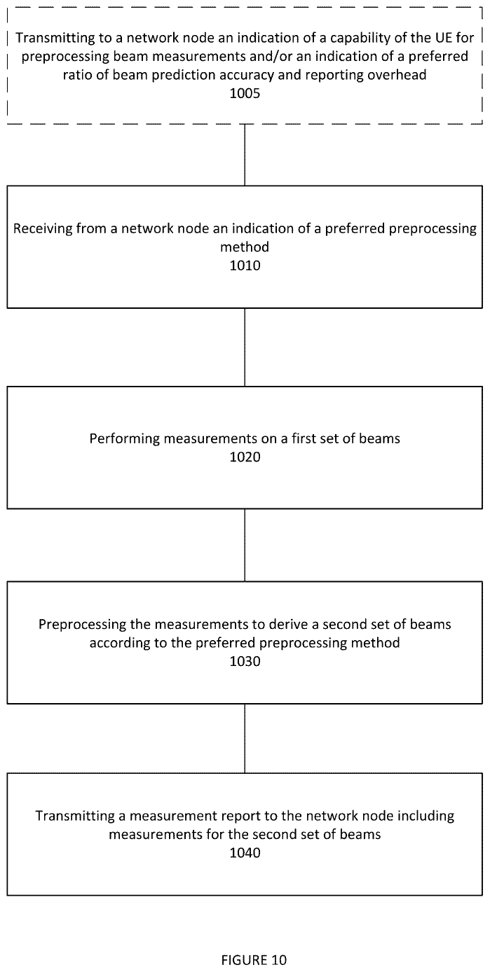

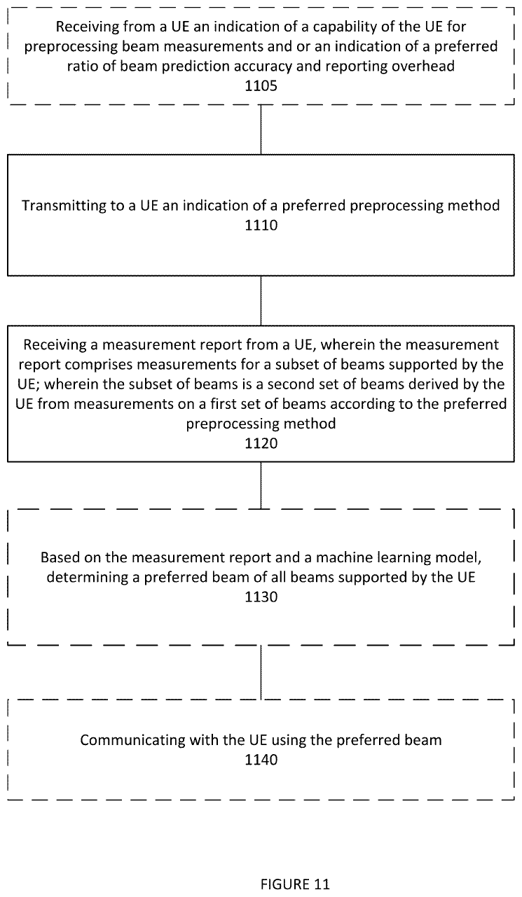

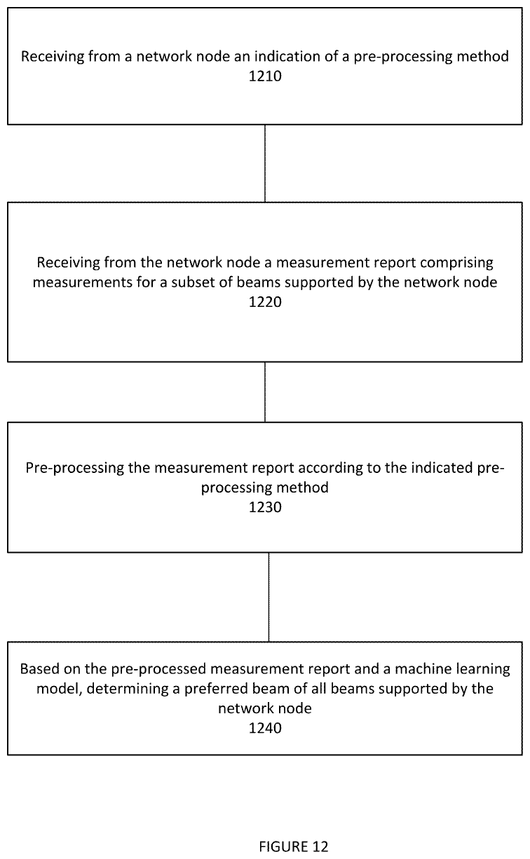

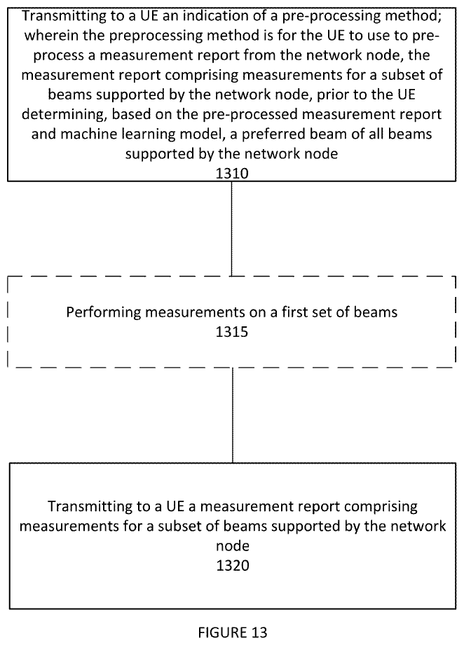

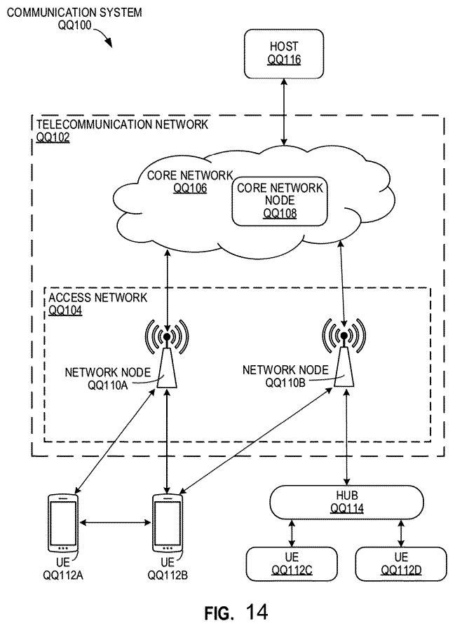

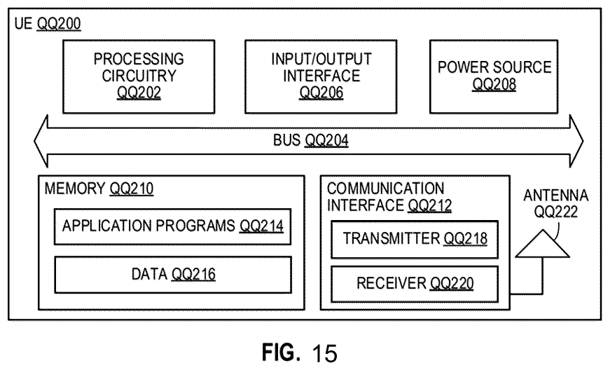

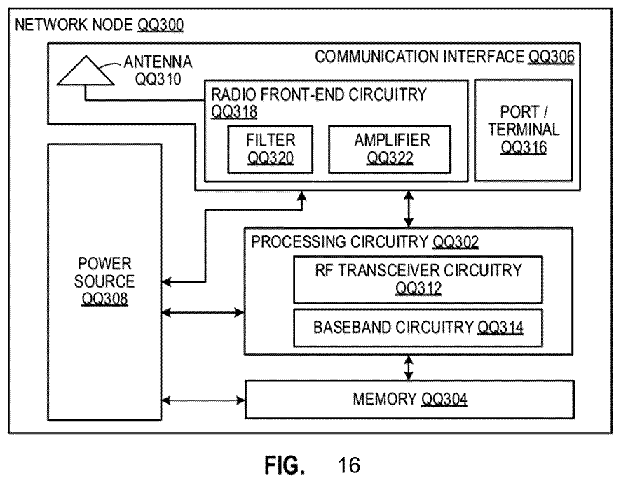

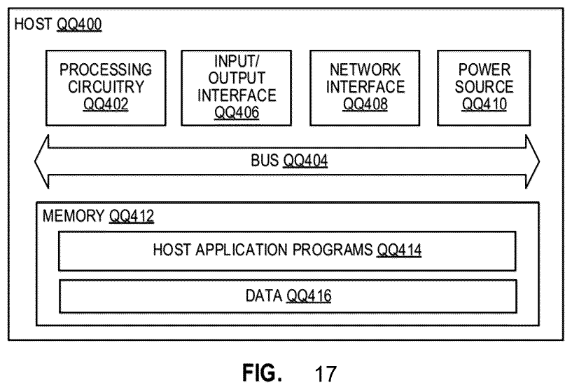

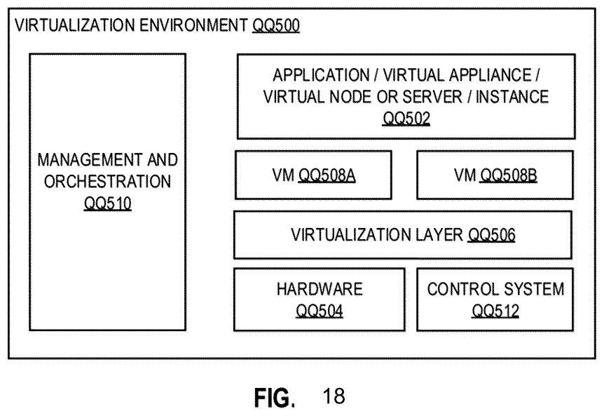

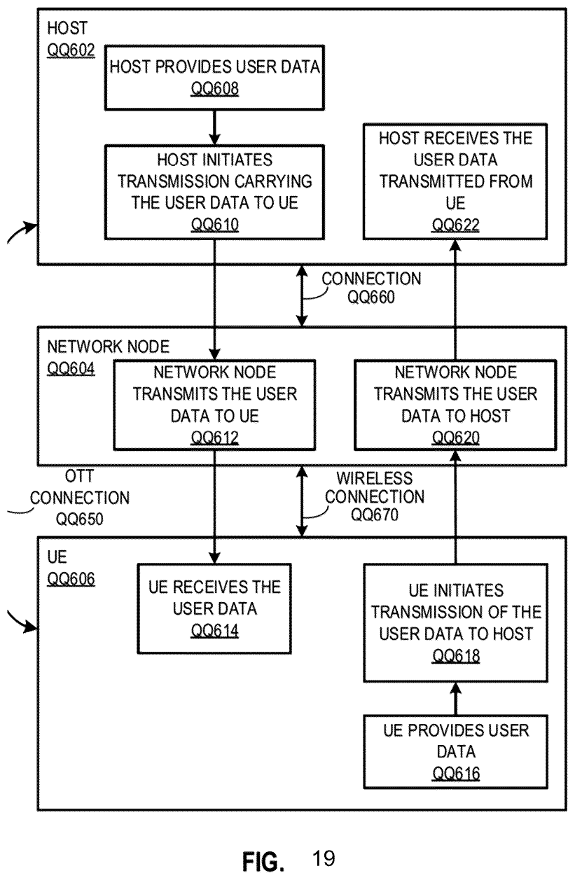

The results are illustrated in Table 1 and FIG. 9, and as can be seen, despite the rather large reporting overhead reduction (up to 80%), performance in terms of RSRP difference compared to optimal beam (genie selection) as well as beam prediction accuracy is small, and in case of 8 SSBs even negligible. Hence, it is clearly demonstrated that methods for reducing reporting overhead are of interest.

TABLE 1

| Scheme | Beam finding accuracy¹ |
|---|---|
| 8 SSB, 100% reported | 95% |
| 8 SSB, 45% reported (X = 10 dB) | 94% |
| 15 CSI-RS, 100% reported | 99% |
| 15 CSI-RS, 36% reported (X = 15 dB) | 98% |
| 15 CSI-RS, 21% reported (X = 10 dB) | 97% |

¹Fraction of selected beams that have an RSRP within 1 dB of the optimal beam

### Pre-Processing

Preprocessing comprises processing the radio measurements of N DL-RS resources (beams), denoted x1, . . . xN. The measurements may comprise the RSRP, RSRQ, SINR, SNR, or any other signal quality metric of each measured DL-RS resource (beam). The pre-processing techniques can both be deployed at the UE or NW side. However, the NW needs to signal to the UE the selected UE-sided pre-processing. This is needed because the pre-processing method should match the method used during training.

For model training at the NW side, the collected channel measurements for the N DL-RS resources (or N beams) are preprocessed to create data for model training, see step 120 in FIG. 6.

In an embodiment, the NW performs preprocessing of the collected radio measurements on N DL-RS resources (beams), by replacing the channel measurements associated with some of the N DL-RS resources (beams) with one or more fixed value(s).

Examples of a pre-processing technique includes a radio measurement value of a DL-RS resource (a beam) is set to a fixed value, if the measurement value is not within a threshold range of the highest measurement value among the N measured DL-RS resources (e.g., X dB lower than the measurement value associated with the strongest beam). For example, let xᵢ denote the L1-RSRP value of DL-RS resource i (beam i) in the dB scale, then, the NW sets xᵢ=x_{fix} if xᵢ<=max(x₁, . . . , x_{N})−X, for all i in {1, 2, . . . , N}. Here, x_{fix} is a fixed L1-RSRP value, and X is a threshold value with respect to the highest L1-RSRP value of the N measured DL-RS resources (beams).

Another example pre-processing technique is a radio measurement value of a DL-RS resource (a beam) is set to a fixed value, if the measurement value is not within the top K measurement values among all the N measurement values for the N DL-RS resources (N measured beams), where K<N. For example, let xᵢ denote the L1-RSRP value of DL-RS resource i (beam i) in the dB scale, then, the NW sets xᵢ=x_{fix} if xᵢ is not the top K values in {x₁, . . . , x_{N}}.

Another example pre-processing technique is a radio measurement value of a DL-RS resource (a beam) is set to a fixed value if the measurement value is below a certain threshold. For example, let xᵢ denote the L1-RSRP value of DL-RS resource i (beam i) in the dB scale and let xₜₕ denote a threshold L1-RSRP value, then, the NW sets xᵢ=x_{fix} if xᵢ<=xₜₕ, for all i in {1, 2, . . . , N}. In a special case, xₜₕ=x_{fix}.

Another example pre-processing technique is that the beam measurements are subject to quantization (e.g. 4 bits per beam meas.).

Another example pre-processing technique is normalization such as scaling to a range, clipping, log scaling

In some embodiments, pre-processing may include any combination of the above techniques.

In some embodiments, a radio measurement value of a DL-RS resource (a beam) is set to a fixed value, if the measurement value is not within a threshold range of the highest measurement value among the N measured DL-RS resources (e.g., X dB lower than the measurement value associated with the strongest beam), or/and if the measurement value is not within the top K measurement values among all the N measurement values for the N DL-RS resources (N measured beams), where K<N, or/and if the measurement value is below a certain threshold.

In some embodiments, the criteria for setting a radio measurement value of a DL-RS resource (a beam) to a fixed value (e.g., the value of X dB, the value of K or/and the value of xₜₕ) is/are considered as model hyper parameter(s) and optimized in the model training process.

In some embodiments, the criteria for setting a radio measurement value of a DL-RS resource (a beam) to a fixed value (e.g., the value of K) is/are designed by considering the requirements on UE data processing capability and/or UE CSI reporting capability for this beam prediction feature.

For model inference, the NW signaling to a UE about the CSI reporting configurations and the required UE-sided data pre-processing method; the UE performs radio measurements on the configured DL-RS resources (beams), performs per-processing on the measurements, and reports the processed radio measurements to the NW. The NW uses the received UE report to create input data for model inference, see steps 220-240 in FIG. 7.

In an embodiment, a channel measurement data preprocessing rule is defined in the specification for beam prediction. A message is sent from a NW to a UE to indicate the data pre-processing method.

In some embodiments, the data preprocessing rule consists of one or more of the following: (a) a radio measurement value of a DL-RS resource (a beam) is set to a fixed value, if the measurement value is not within a threshold range of the highest measurement value among the N measured DL-RS resources (e.g., X dB lower than the measurement value associated with the strongest beam); (b) a radio measurement value of a DL-RS resource (a beam) is set to a fixed value, if the measurement value is not within the top K measurement values among all the N measurement values for the N DL-RS resources (N measured beams), where K<N; and/or (c) a radio measurement value of a DL-RS resource (a beam) is set to a fixed value if the measurement value is below a certain threshold.

In some embodiments, the message sent from NW to UE consists of parameters used as the criteria for setting a radio measurement value of a DL-RS resource (a beam) to a fixed value (e.g., the value of X dB, the value of K or/and the value of xₜₕ).

In some embodiments, the message sent from NW to UE is sent in a UE-specific RRC message (e.g., contained in the message used for configuring the CSI report settings for the UE or a new RRC message that is designed for data collection), in a system information message (e.g., a SIB message that is broadcasted to all UEs), a DCI format (e.g., a DCI format that is used to trigger the CSI measurement report form the UE), or a combination of the above methods.

As an example, consider the case that a rule is defined for UE-sided radio measurement data pre-processing for beam prediction, such that a radio measurement value of a DL-RS resource (a beam) is set to a fixed value, if the measurement X dB lower than the measurement value associated with the strongest beam.

One example method for the NW to indicate a selected value of X to UE is to use a combined signaling of a RRC message and a DCI signaling. For instance, the NW can define a finite set of values for X, and the set of values for X is signaled from the NW to the UEs using a RRC message. When the NW uses a DCI to trigger a UE to report the processed CSI measurements for model inference at the NW side, a bit-field within the DCI format can be used to indicate which value of X the UE should use for pre-processing the CSI measurements. In case there is no bit-field in the DCI used for indicating the value of X, then, the UE shall select the first value of the set of values configured for X in the RRC message.

Another example method for the NW to indicate a selected value of X to UE is to use a RRC message: A finite set of values for X is defined in the specification, and the selected value of X is signaled from the NW to the UEs using a RRC message.

Another example method for the NW to indicate a selected value of X to UE is to use a DCI signaling: A finite set of values for X is defined in the specification, and the selected value of X is signaled from the NW to the UEs using a DCI signaling, the DCI can be the one that is used for the NW to trigger the CSI reporting from the UE.

### Training the Model (Step 100-150)

### Data Collection (Step 100)

During the training phase, the network performs beam sweeping over all potential beams in set A so that the UE can measure the signal strength of each transmitted beam. For facilitating the collection, the UE feeds back, e.g., the signal strength in terms of RSRPs obtained from the full set of swept beams. The data can be collected via the UE reports all potential beams in set A and set B (in case it is not a subset of A).

### Pre-Processing and Training (Step 110/130)

In the pre-processing step prior to model training, the NW can for example have a set of thresholds to be used when training the model. Where threshold can comprise the threshold of which beam is not set to a fixed value in case it is not within the strongest beam value. Next, the NW evaluates the potential thresholds and estimates accuracy plus overhead information. The NW then can save models with the information on the trade-off between accuracy and overhead. This is used in the model selection step to find the best model in a certain scenario.

The NW can use any of commonly used ML-models such as random forest, neural networks, nearest neighbor, etc.

Note that although not desirable, the network may be trained with one pre-processing and used in a live NW with a somewhat different pre-processing step.

### Model Performance Estimation (Step 140/150)

After the model(s) are trained, the NW can deploy the set of models for performing inference. The NW can alternatively change the pre-processing in case the accuracy for one or more of the models are insufficient.

### AI/ML Model Inference (Step 200-260)

### UE Capabilities and Required Reporting Overhead and Prediction Accuracy

### UE Preferred Trade-Off

The UE can for example indicate to have a certain acceptable L1-RSRP difference in comparison to being served by strongest beams. For example, it can tolerate a loss of x dB in the 90-th percentile in case it can save BM reporting by y %. Or that the NW should optimize the need for reporting overhead if it can fulfill the service requirements, for example certain bitrate value.

### Model Selection

In the training step, the NW can train multiple models that provide a different trade-off between accuracy and reporting overhead reduction.

The NW can select a model based on: the UE preferred configuration, UE service requirements, UE type (smartphone, sensor, vehicle, drone . . . ), and/or the NW load situation. For example, the network needs to save uplink resources if a large number of UEs are connected.

### UE Measurement and Pre-Processing (Step 230, 240a, 240b)

The NW indicates to the UE how to perform the pre-processing. Using any of the methods outlined above.

UEs in LTE and NR are required to monitor the downlink link quality based on the reference signal(s), perform the measurements on the reference signals (e.g., SS-RSRP, SS-RSRQ, SS-SINR for NR cells) of the identified cells and report the measured samples to the network, according to the requirements specified in the TS 36.133 for LTE and TS 38.133 for NR respectively.

The UE can report RSRP/SINR/RSRQ using existing NR measurement events, described in the section 9 in TS 38.133, for example, using periodic reporting, or event triggered reporting.

The UE sends a measurement report when the conditions as configured by the network are fulfilled. These conditions may be time based (e.g., periodic reporting) or the received signal related measurement based (e.g., event triggered reporting). The event triggered reporting is associated with RSRP (reference signal received power), RSRQ (reference signal received quality) or SINR (signal to interference and noise ratio) related measurements. The measurements used for evaluating the event triggering criterion are Layer 3 (L3) filtered.

One type of measurement report is the report of beam measurement information. The reportType can be set to eventTriggered or periodical. The measurement information to be included can be based on SS/PBCH block (SSB) or CSI-RS. In some embodiments, layer 3 (RRC) beam measurement information is expanded to have been derived using the indicated pre-processing from the network node.

For beam management, a UE can be configured to report L1-RSRP or/and L1-SINR for each one of up to four different CSI-RS/SSB beams. The UE measurement report can be sent either over PUCCH or PUSCH to the NW, depending on the CSI reporting types (periodic CSI reporting, semi-persistent CSI reporting or aperiodic CSI reporting.) In an embodiment, the configuration is expanded to include the pre-processing described herein, and the UE may as a result of the pre-processing report more than four different CSI-RS/SSB beams.

In the following, several examples of pre-processing in the UE are given, in particular methods to filter to reduce the number of reported beams.

In general, any embodiments described above with “setting to a fixed value” replaced by “not reported” is an embodiment for inference. For example, the following methods are embodiments for inference:
1. Only beams within X dB of the strongest beam are selected for reporting.
2. The UE filters according to 1. But additionally select some beam(s) according to some other criterion, e.g. all beam(s) with angle that differs more than Y degrees from any of the other kept beams
3. The K strongest beams are selected for reporting.
4. Select beams that are among the K strongest and also fulfill some other criterion, e.g. the selection criteria in any of 1, and 2.
5. Select beams according to 3., but additionally select any beams that are at most Y dB weaker than the weakest of those beams
6. Select beams according to E4, but additionally select any beams that are at most Y dB weaker than the weakest of those beams
7. Select beams according to 1., and additionally select beams that are at most Y dB weaker than the weakest of those beams

### UE Beam Reporting

A CSI report transmitted from the UE to the network consists of one or more CSI fields, where each CSI-field consists of one or more bits. The structure of the CSI report (e.g., the number of CSI-fields, the order of the CSI-fields, and the number of bits per CSI field, etc.) needs to be known by the UE such that the UE knows which value each of the bits in the CSI report should be set to (based on the CSI measurements). In a similar way the network needs to know the structure of the CSI report the UE assumed when transmitting the report, such that the network can decode the information in a correct way.

For a beam report in NR, the number of CSI-fields can be derived from the number of beams the UE shall report, as illustrated in Table 2. Because the number of beams the UE shall report is part of the CSI report configuration of the triggered beam report, both the UE and the network knows which kind of bit mapping (e.g. the number of CSI-fields, the order of the CSI-fields, and the number of bits per CSI field, etc.) that the UE should use for the beam report.

TABLE 2
Mapping order of CSI fields of one report for CRI/RSRP
or SSBRI/RSRP reporting as specified n TS 38.312

| CSI report | |
|---|---|
| number | CSI fields |
| CSI report | CRI or SSBRI #1 as in Table 6.3.1.1.2-6, if |
| #n | reported |
| | CRI or SSBRI #2 as in Table 6.3.1.1.2-6, if |
| | reported |
| | CRI or SSBRI #3 as in Table 6.3.1.1.2-6, if |
| | reported |
| | CRI or SSBRI #4 as in Table 6.3.1.1.2-6, if |
| | reported |
| | RSRP #1 as in Table 6.3.1.1.2-6, if reported |
| | Differential RSRP #2 as in Table 6.3.1.1.2-6, if |
| | reported |
| | Differential RSRP #3 as in Table 6.3.1.1.2-6, if |
| | reported |
| | Differential RSRP #4 as in Table 6.3.1.1.2-6, if |
| | reported |

For some embodiments, the number of beams included in the beam report will differ depending on the current channel conditions. For example, assume that the UE only shall include beams in the beam report that is within X dB of the strongest beam. In this case, the number of beams included in the report depends on how many beams that are closer than X dB to the strongest beam. However, for a fixed size beam report, the beam reporting overhead will not be reduced when fewer beams are reported (which was the purpose of reducing the number of beams in the beam report).

Thus, in some embodiments, the beam report is divided into two parts, where a first part (Part 1) is fixed in size and the second part (Part 2) varies in size based on what is indicated in Part 1. In some embodiments, Part 1 consists of the beam ID of the strongest beam, the absolute RSRP value of the strongest beam, and the number of beams included in the second part of the beam report. In this way, the network will know how Part 2 of the beam report is structured and can decode the reported beam information of Part 2 accordingly. However, note that it is possible that other type of information is included in Part 1. The important thing is that the size of Part 2 is indicated in Part 1 (for example by indicating the number of beams reported in Part 2)

As can be seen in Table 2, absolute RSRP is only reported for the strongest beam, and for the remaining N−1 beams, a differential RSRP compared to the strongest RSRP is reported. The CSI-field for the differential RSRP currently consists of 4 bits and give the offset RSRP value compared to the best beam in the range from 0 to −30 dB. However, if the UE only shall report beams that are within X dB compared to the strongest reported beam (according to one of the embodiments in the proposed invention), it might not be necessary to have a differential reporting all the way down to −30 dB.

For example, if X is equal to 10 dB, then it is enough that the differential RSRP goes from 0 to −X dB. In one embodiment, when the UE is configured to only report beams within X dB from the strongest reported beam, the number of bits used to report the differential RSRP is adapted accordingly. For example, because 4 bits is used to report RSRP from 0 to −30 dB, in case X is equal to −15 dB, the differential RSRP might be reported using only 2 bits. In this case the beam report overhead is reduced without any negative impact on the performance. In another embodiment, the same number of bits is used for the reporting the differential RSRP regardless of X, but the scaling of the differential RSRP range is changed. For example, if X=15, 4 bits are still used to report the differential RSRP, but the granularity of each step of the differential RSRP is reduced. One advantage with this solution is that the accuracy of the RSRP report is improved without increasing the beam reporting overhead.

### NW Model Inference and Beam Selection (Step 250/260)

Next, the UE reported measurements are used as input for the trained beam prediction model. The model output is used to derive the best beam to use during the data transmission.

The NW node for training the model could be any core network node (OAM,MME), and is not limited to the node that performs the inference (e.g. eNB, gNB).

FIG. 10 is a flow chart showing a method in a User Equipment, UE, according to an aspect of the present invention. The method comprises at 1010 receiving from a network node an indication of a preferred preprocessing method. The method further comprises at 1020 performing measurements on a first set of beams and at 1030 preprocessing the measurements to derive a second set of beams according to the preferred preprocessing method. The method further comprises at 1040 transmitting a measurement report to the network node, wherein the measurement report comprises measurements for the second set of beams.

Advantageously, beam reporting overhead may therefore be reduced, since the UE may report measurements for fewer beams, whilst limiting a reduction in accuracy of preferred beam prediction based on the measurement report.

The second set of beams may include fewer beams than the first set of beams. The second set of beams may be a subset of the first set of beams.

The method may further comprise at 1005 transmitting to a network node an indication of a capability of the UE for preprocessing beam measurements and/or transmitting to a network node an indication of a capability of the UE for reporting beam measurements that have been preprocessed using the preferred preprocessing method and/or transmitting to a network node an indication of a preferred ratio of beam prediction accuracy and reporting overhead.

According to embodiments, the preprocessing at 1030 may comprise selecting a subset of the first set of beams. The second set of beams may comprise or consist of this subset. For example, the preprocessing may comprise selecting a subset of the first set of beams based on whether a signal quality measurement value for a beam is within a threshold range, X, of a highest signal quality measurement value for a beam in the first set of beams. In another example, the preprocessing may comprise selecting a subset of the first set of beams based on whether a signal quality measurement value for a beam is within the highest K measurement signal quality values for the first set of beams. In another example, the preprocessing may comprise selecting a subset of the first set of beams based on whether a signal quality measurement value for a beam is below a signal quality measurement threshold, x.

According to embodiments, the first set of beams may be a subset of all beams supported by the wireless device, for example the first of beams may be Set B beams described above.

According to an embodiment, receiving at 1010, from the network node, the indication of the preferred preprocessing method may comprise receiving a message from the network node comprising a parameter. The parameter may be for use as a criterion for whether to select a beam from the first set of beams for inclusion in the second set of beams. For example, the parameter may comprise a value for a signal quality measurement threshold range, X; a value for a number, K, of highest signal quality measurements; or a value for a signal quality measurement threshold, x.

In embodiments, the message may be a Radio Resource Control, RRC, message, a system information message or a Downlink Control Information, DCI.

In an example, receiving at 1010, from the network node, the indication of the preferred preprocessing method comprises receiving a RRC message comprising a set of values for the parameter and receiving a DCI indicating a selected value from the set of values. Advantageously, this method may enable more dynamic activation of different preferred preprocessing methods, according to conditions.

According to an embodiment, the measurement report may comprise a first part and a second part, wherein the first part comprises an indication of a number of beams for which measurements are included in the second part.

In an embodiment, a number of bits used to report a measurement for at least one of the second set of beams depends on the preferred preprocessing method. Thus, the overhead for a beam report may be even further reduced.

In another embodiment, a granularity of a measurement reported for at least one of the second set of beams depends on the preferred preprocessing method. In this case, the number of bits to report each beam in the second set of beams may remain the same, but the accuracy of the report may be increased.

FIG. 11 is a flow chart showing a method in a network equipment according to an aspect of the present invention. The method comprises at 1110 transmitting to a User Equipment, UE, an indication of a preferred preprocessing method. The method further comprises at 1120 receiving a measurement report from the UE, wherein the measurement report comprises measurements for a subset of beams supported by the UE; wherein the subset of beams is a second set of beams derived by the UE from measurements on a first set of beams according to the preferred preprocessing method.

The method may further comprise at 1130 based on the measurement report and a machine learning model, determining a preferred beam of all beams supported by the UE; and at 1140 communicating with the UE using the preferred beam.

The method may further comprise receiving at 1105 from a UE an indication of a capability of the UE for preprocessing beam measurements and/or an indication of a preferred ratio of beam prediction accuracy and reporting overhead.

The preferred preprocessing method may comprise any of the methods described above, and the indication of the preferred preprocessing method may comprise any of the examples described above.

FIG. 12 is a further flow chart showing a method in a user equipment according to a further aspect of the present invention, in this case where a machine learning model for predicting a preferred beam is situated in the UE. The method comprises at 1210 receiving, from the network node, an indication of a pre-processing method. The method further comprises at 1220 receiving, from a network node, a measurement report comprising measurements for a subset of beams supported by the network node. The method further comprises at 1230 pre-processing the measurement report according to the indicated preprocessing method and at 1240, based on the pre-processed measurement report and a machine learning model, determining a preferred beam of all beams supported by the network node.

According to an embodiment, the pre-processing may comprise assigning one or more non-reported beams a fixed value.

The indication of the pre-processing method may comprise the fixed value.

FIG. 13 is a further flow chart showing a method in a network node according to this further aspect of the present invention. The method comprises at 1310 transmitting, to the UE, an indication of a pre-processing method. The pre-processing method is for the wireless device to use to pre-process a measurement report from the network node, the measurement report comprising measurements for a subset of beams supported by the network node, prior to the UE determining, based on the pre-processed measurement report and a machine learning model, a preferred beam of all beams supported by the network node. The method further at 1320 comprises transmitting, to the User Equipment, a measurement report comprising measurements for a subset of beams supported by the network node.

The method may further comprise at 1315 performing measurements on a first set of beams, which may include at least the subset of beams. It will be understood that, in this embodiment, the network node may receive one or more reference signals from the UE on which the network node can perform a signal quality measurement for the first set of beams. The network node may therefore perform measurements on the first set of beams based on the one or more reference signals from the UE. The network node may further pre-process the measurements to derive the subset of beams, for example using any of the methods described above. However, it will be understood that it is not necessary for the UE to know the details of how the network node pre-processes beam measurements. Instead, the UE only needs to know which, if any, pre-processing method to apply to the measurement report, in order to most accurately determine a preferred beam based on the measurement report and a machine learning model.

FIG. 14 shows an example of a communication system QQ100 in accordance with some embodiments. In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting Ues QQ112a, QQ112b, QQ112c, and QQ112d (one or more of which may be generally referred to as Ues QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, Ues, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The Ues QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the Ues QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the Ues, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of Ues, analytics functionality, social media, functions for controlling or otherwise interacting with remote devices, functions for an alarm and surveillance center, or any other such function performed by a server.

As a whole, the communication system QQ100 of FIG. 13 enables connectivity between the Ues, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some Ues, while providing Enhanced Mobile Broadband (eMBB) services to other Ues, and/or Massive Machine Type Communication (mMTC)/Massive IoT services to yet further Ues.

In some examples, the Ues QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub QQ114 communicates with the access network QQ104 to facilitate indirect communication between one or more Ues (e.g., UE QQ112c and/or QQ112d) and network nodes (e.g., network node QQ110b). In some examples, the hub QQ114 may be a controller, router, content source and analytics, or any of the other communication devices described herein regarding Ues. For example, the hub QQ114 may be a broadband router enabling access to the core network QQ106 for the Ues. As another example, the hub QQ114 may be a controller that sends commands or instructions to one or more actuators in the Ues. Commands or instructions may be received from the Ues, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the Ues, in particular in if one or more of the Ues are low energy IoT devices.

The hub QQ114 may have a constant/persistent or intermittent connection to the network node QQ110b. The hub QQ114 may also allow for a different communication scheme and/or schedule between the hub QQ114 and Ues (e.g., UE QQ112c and/or QQ112d), and between the hub QQ114 and the core network QQ106. In other examples, the hub QQ114 is connected to the core network QQ106 and/or one or more Ues via a wired connection. Moreover, the hub QQ114 may be configured to connect to an M2M service provider over the access network QQ104 and/or to another UE over a direct connection. In some scenarios, Ues may establish a wireless connection with the network nodes QQ110 while still connected via the hub QQ114 via a wired or wireless connection. In some embodiments, the hub QQ114 may be a dedicated hub—that is, a hub whose primary function is to route communications to/from the Ues from/to the network node QQ110b. In other embodiments, the hub QQ114 may be a non-dedicated hub—that is, a device which is capable of operating to route communications between the Ues and network node QQ110b, but which is additionally capable of operating as a communication start and/or end point for certain data channels.

FIG. 14 shows a UE QQ200 in accordance with some embodiments. The UE QQ200 comprises processing circuitry QQ202 configured to perform any of the methods described above as performed by a UE. As used herein, a UE refers to a device capable, configured, arranged and/or operable to communicate wirelessly with network nodes and/or other Ues. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

In this example, the UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain Ues may utilize all or a subset of the components shown in Figure QQ2. The level of integration between the components may vary from one UE to another UE. Further, certain Ues may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in Figure QQ2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of Ues may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node QQ300 in accordance with some embodiments. The network node QQ300 comprises processing circuitry QQ302 configured to perform any of the above described methods which are performed by a network node.

As used herein, network node refers to equipment capable, configured, arranged and/or operable to communicate directly or indirectly with a UE and/or with other network nodes or equipment, in a telecommunication network. Examples of network nodes include, but are not limited to, access points (Aps) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

In this example, the network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or Ues via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in Figure QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. 16 is a block diagram of a host QQ400, which may be an embodiment of the host QQ116 of FIG. 14, in accordance with various aspects described herein.

As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more Ues.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of Ues (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment QQ500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units. FIG. 18 shows a communication diagram of a host QQ602 communicating via a network node QQ604 with a UE QQ606 over a partially wireless connection in accordance with some embodiments.

Example implementations, in accordance with various embodiments, of the UE (such as a UE QQ112a of FIG. 14 and/or UE QQ200 of FIG. 15), network node (such as network node QQ110a of FIG. 14 and/or network node QQ300 of FIG. 16), and host (such as host QQ116 of FIG. 14 and/or host QQ400 of FIG. 17) discussed in the preceding paragraphs will now be described with reference to FIG. 19.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 14) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to Ues. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., Ues, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Some embodiments are set out in the following numbered clauses.
1. A method performed by a wireless device, the method comprising:
   performing channel state measurements on a first set of beams;
   preprocessing the measurements to derive a second set of beams; and
   transmitting a measurement report to a network node, the measurement report comprises measurements for the second set of beams.
2. The method of the previous embodiment, further comprising transmitting to a network node an indication of a capability of the wireless device for preprocessing channel state measurements.
3. The method of any one of the previous embodiments, further comprising transmitting to a network node an indication of a capability of the wireless device for reporting channel state measurements.
4. The method of any one of the previous embodiments, further comprising transmitting to a network node an indication of a preferred ratio of beam prediction accuracy and reporting overhead.
5. The method of any one of the previous embodiments, wherein the preprocessing comprises any of the preprocessing steps in the embodiments and examples described above.
6. The method of any one of the previous embodiments, further comprising receiving from the network node an indication of a preferred preprocessing method.
7. A method performed by a wireless device, the method comprising:
   any of the wireless device steps, features, or functions described above, either alone or in combination with other steps, features, or functions described above.
8. The method of the previous embodiment, further comprising one or more additional wireless device steps, features or functions described above.
9. The method of any of the previous embodiments, further comprising:
   providing user data; and
   forwarding the user data to a host computer via the transmission to the base station.
10. A method performed by a base station, the method comprising:
   receiving a measurement report from a wireless device, the measurement report comprises measurements for a subset of beams supported by the wireless device;
   based on the measurement report and a machine learning model, determining a preferred beam of all beams supported by the wireless device; and
   communicating with the wireless device using the preferred beam.
11. The method of the previous embodiment, further comprising receiving from a wireless device an indication of a capability of the wireless device for preprocessing channel state measurements.
12. The method of any one of the previous embodiments, further comprising receiving from a wireless device an indication of a capability of the wireless device for reporting channel state measurements.
13. The method of any one of the previous embodiments, further comprising receiving from a wireless device an indication of a preferred ratio of beam prediction accuracy and reporting overhead.
14. The method of any one of the previous embodiments, further comprising transmitting to the wireless device an indication of a preferred preprocessing method.
15. A method performed by a base station, the method comprising:
   any of the steps, features, or functions described above with respect to base station, either alone or in combination with other steps, features, or functions described above.
16. The method of the previous embodiment, further comprising one or more additional base station steps, features or functions described above.
17. The method of any of the previous embodiments, further comprising:
   obtaining user data; and
   forwarding the user data to a host computer or a wireless device.
18. A mobile terminal comprising:
   processing circuitry configured to perform any of the steps of any of the wireless device embodiments; and
   power supply circuitry configured to supply power to the wireless device.
19. A base station comprising:
   processing circuitry configured to perform any of the steps of any of the network node embodiments;
   power supply circuitry configured to supply power to the wireless device.
20. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
21. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the network node embodiments.
22. The communication system of the pervious embodiment further including the base station.
23. The communication system of the previous 2 embodiments, further including the UE, wherein the UE is configured to communicate with the base station.
24. The communication system of the previous 3 embodiments, wherein:
   the processing circuitry of the host computer is configured to execute a host application, thereby providing the user data; and
   the UE comprises processing circuitry configured to execute a client application associated with the host application.
25. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the network node embodiments.
26. The method of the previous embodiment, further comprising, at the base station, transmitting the user data.
27. The method of the previous 2 embodiments, wherein the user data is provided at the host computer by executing a host application, the method further comprising, at the UE, executing a client application associated with the host application.
28. A user equipment (UE) configured to communicate with a base station, the UE comprising a radio interface and processing circuitry configured to performs any of the previous 3 embodiments.
29. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the UE embodiments.
30. The communication system of the previous embodiment, wherein the cellular network further includes a base station configured to communicate with the UE.
31. The communication system of the previous 2 embodiments, wherein:
   the processing circuitry of the host computer is configured to execute a host application, thereby providing the user data; and
   the UE's processing circuitry is configured to execute a client application associated with the host application.
32. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the UE embodiments.
33. The method of the previous embodiment, further comprising at the UE, receiving the user data from the base station.
34. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the UE embodiments.
35. The communication system of the previous embodiment, further including the UE.
36. The communication system of the previous 2 embodiments, further including the base station, wherein the base station comprises a radio interface configured to communicate with the UE and a communication interface configured to forward to the host computer the user data carried by a transmission from the UE to the base station.
37. The communication system of the previous 3 embodiments, wherein:
   the processing circuitry of the host computer is configured to execute a host application; and
   the UE's processing circuitry is configured to execute a client application associated with the host application, thereby providing the user data.
38. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
39. A method implemented in a communication system including a host computer, a base station and a user equipment (UE), the method comprising:
   at the host computer, receiving user data transmitted to the base station from the UE, wherein the UE performs any of the steps of any of the UE embodiments.
40. The method of the previous embodiment, further comprising, at the UE, providing the user data to the base station.
41. The method of the previous 2 embodiments, further comprising:
   at the UE, executing a client application, thereby providing the user data to be transmitted; and
   at the host computer, executing a host application associated with the client application.
42. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
43. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the network node embodiments.
44. The communication system of the previous embodiment further including the base station.
45. The communication system of the previous 2 embodiments, further including the UE, wherein the UE is configured to communicate with the base station.
46. The communication system of the previous 3 embodiments, wherein:
   the processing circuitry of the host computer is configured to execute a host application;
   the UE is configured to execute a client application associated with the host application, thereby providing the user data to be received by the host computer.
47. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the UE embodiments.
48. The method of the previous embodiment, further comprising at the base station, receiving the user data from the UE.
49. The method of the previous 2 embodiments, further comprising at the base station, initiating a transmission of the received user data to the host computer.

1.-28. (canceled)

29. A method performed by a User Equipment, UE, the method comprising:
receiving from a network node an indication of a preferred preprocessing method;
performing measurements on a first set of beams;
preprocessing the measurements to derive a second set of beams according to the preferred preprocessing method; and
transmitting a measurement report to the network node, wherein the measurement report comprises measurements for the second set of beams.

30. The method of claim 29, wherein the preprocessing comprises selecting a subset of the first set of beams based on whether a signal quality measurement value for a beam is within a threshold range, X, of a highest signal quality measurement value for a beam in the first set of beams.

31. The method according to claim 29, wherein receiving from the network node the indication of the preferred preprocessing method comprises receiving a message from the network node comprising a parameter.

32. The method according to claim 31, wherein the parameter is for use as a criterion for whether to select a beam from the first set of beams for inclusion in the second set of beams.

33. The method according to claim 31, wherein the parameter comprises a value for a signal quality measurement threshold range, X.

34. The method according to claim 31, wherein the message is a Radio Resource Control, RRC, message.

35. The method according to claim 31, where the message is a system information message or a Downlink Control Information, DCI.

36. The method according to claim 31, wherein receiving from the network node the indication of the preferred preprocessing method comprises: receiving a RRC message comprising a set of values for the parameter; and receiving a DCI indicating a selected value from the set of values.

37. The method according to claim 31, wherein the measurement report comprises a first part and a second part; wherein the first part comprises an indication of a number of beams for which measurements are included in the second part.

38. The method according to claim 31, wherein a number of bits used to report a measurement for at least one of the second set of beams depends on the preferred preprocessing method.

39. The method according to claim 31, wherein a granularity of a measurement reported for at least one of the second set of beams depends on the preferred preprocessing method.

40. A method performed by a network node, the method comprising:
transmitting to a User Equipment, UE, an indication of a preferred preprocessing method;
receiving a measurement report from the UE, wherein the measurement report comprises measurements for a subset of beams supported by the UE; wherein the subset of beams is a second set of beams derived by the UE from measurements on a first set of beams according to the preferred preprocessing method.

41. The method according to claim 40, wherein the subset of beams in the measurement report is selected from the first set of beams based on whether a signal quality measurement value for a beam is within a threshold range, X, of a highest signal quality measurement value for a beam in the first set of beams

42. The method according to claim 40, wherein transmitting to the UE the indication of the preferred preprocessing method comprises transmitting a message to the UE comprising a parameter.

43. The method according to claim 42, wherein the parameter is for use as a criterion for whether to select a beam from the first set of beams for inclusion in the second set of beams.

44. The method according to claim 42, wherein the parameter comprises a value for a signal quality measurement threshold range, X.

45. The method according to claim 42, wherein the message is a Radio Resource Control, RRC, message.

46. The method according to claim 40, further comprising: based on the measurement report and a machine learning model, determining a preferred beam of all beams supported by the UE; and communicating with the UE using the preferred beam.

47. A User Equipment, UE, comprising:
processing circuitry configured to perform the method of claim 1; and
power supply circuitry configured to supply power to the UE.

48. A network node comprising:
processing circuitry configured to perform the method of claim 40; and
power supply circuitry configured to supply power to the network node.
